(19) United States
(12) Patent Application Publication
(10) Pub. No.: US 2003/0040324 A1
(43) Pub. Date: Feb. 27, 2003

(54) Location based information

(76) Inventors: Charles A. Eldering, Doylestown, PA (US); Frederick M. Dewolf, Ithaca, NY (US); Douglas J. Ryder, Doylestown, PA (US); M. Lamine Sylla, New Britain, PA (US)

Correspondence Address: TECHNOLOGY, PATENTS AND LICENSING, INC., 340 NORTH BROAD STREET, DOYLESTOWN, PA, 18901, US

(21) Appl. No.: 10/115,883

(22) Filed: Apr. 4, 2002

Related U.S. Application Data
(60) Provisional application No. 60/281,499, filed on Apr. 4, 2001.

(51) Int. Cl. H04Q 7/00

(52) U.S. Cl. 455/456; 455/457

(57) ABSTRACT

A method and system for providing location-based information to a mobile or fixed subscriber. A subscriber requests information through an information manager which maintains a location-indexed database (L-database) containing web servers addresses of entities hosting information of interest to the subscriber. The subscriber requests the information through a handheld device ( wireless phone or PDA) or through a desktop or laptop PC. The information manager receives also the subscriber's current location information in terms of street address or geo-location and queries the L-database to identify entities hosting the requested information. The information is then retrieved directly from the identified servers and presented to the subscriber in a format suitable to the subscriber device.

### CROSS-REFERENCE

This application claims priority under 35 U.S.C. §119(e) for Provisional application No. 60/281,499, filed on Apr. 4, 2001 entitled “Location Based Information” (Docket No. L102-00). The aforementioned application is herein incorporation by reference, but is not admitted to be prior art.

### BACKGROUND OF THE INVENTION

The advent of wireless communications provides the ability for users to communicate and make transactions from a moving location. However, this mobility makes it difficult to associate the user to a specific location. Users of cellular telephones (also known as mobile or wireless) have been at a disadvantage when it came to availing themselves of the Emergency 911 System. Traditional fixed position telephones provide a caller identification which is mapped to a specific physical location in the call center's database. Accordingly, an appropriate emergency services response can be made without further communication from the caller. Obviously, mobile phones have no fixed position. Accordingly, some type of communication from the caller identifying their present location is required for an appropriate emergency service response to be made.

With the government regulation of the cellular services providers, several inventions have been documented that facilitate the determination of a mobile device's location. The recent developments in technology that allow an individual to determine their position, or location, are becoming wide spread. The work with Global Positioning Satellite Systems (GPSS) is evident in hand held devices that are being used by individuals in combination with personal digital assistants (PDA's). Trimble Navigation's work on personal location assistants (PLA's), U.S. Pat. No. 5,528,248, is an example of the prior art that anticipated such developments.

The unit is comprised of technology sufficient to determine present position as well as a compass that provides for taking readings of present and prior headings. The PDA is capable of receiving a downloadable map and retaining the map in computer memory. The location information from the PLA is then passed to the PDA. A single handheld unit is then capable of providing directional readings, determining the devices position in terms of longitude and latitude by making use of GPSS, and overlaying the co-ordinations on a displayed digital map. The current heading can also then be displayed as an overlay allowing for highly accurate real time navigation.

Another example of the expanding use of this technology is the deployment of vehicle navigation systems developed for the consumer market. These systems are generally found to be of two types.

The first type is comprised of a GPS unit, a compass, a map database, and a user interface (visual and/or with a voice interface). The core functionality of the system (location determination, and relative position on a map) is enhanced by using input from the vehicle to provide other relevant data that can be used in aiding navigation. This input can be the speed of travel, and help in determining if turns (changes in direction) have been taken. This type of system is disclosed in Magellan's U.S. Pat. No. 5,862,511.

The second type of navigation system relies on the combination of a GPS unit, a mobile telephone and a call center. The position of the vehicle is determined by making use of the GPS unit. When a user initiates a session with the call center, the GPS unit relays the coordinates to the call center via a dedicated cellular telephone. The call center is staffed by an operator. The operator is able to view a map with the position of the vehicle displayed on it. The occupant of the vehicle is then able to converse with the call center operator who serves as the navigator, giving instructions and guidance to the occupant of the vehicle. The product literature from Onstar, “OnStar Services,” printed from the World Wide Web site http://www.onstar.com/service/services.htm on Jul. 7, 2000 discloses this type of service. This service is currently being offered as a dedicated service in vehicles which limits its portability and adaptability for use away from the vehicle. Cell-loc's U.S. Pat. No. 5,890,068 provides for a method of determining the location of the device within the cellular phone network by calculating the differences in arrival time of the device's signal at one or more antennas in the system. Snap-Track's U.S. Pat. No. 5,999,124 provides for an alternative method of accomplishing the same.

An alternative technology that is being developed places GPS functionality on a chip. The product literature from Motorola, Inc., “Motorola Announces Oncore™ Remote GPS Precision Timing Receiver”, printed from the World Wide Web site http://www.motorola.com/ies/GPS/pressrls/050498.html on May 5, 2000 discloses such a chipset. This chipset, embedded within a mobile telephone device would provide for the functionality needed to provide for Emergency 911 services. The GPS data could be combined with the caller ID data and forwarded to the call center as the emergency call was placed.

In other recent developments, the capabilities of PDA's have been expanded to provide wireless access to data, notably Palm Computing, Palm VII device and the wireless data service provided by the same company. In product literature from Palm, Inc. “Palm's Web Clipping Network”, obtained from the World Wide Web site http://www.palm.com/pr/palmvii/7whitepaper.pdf published on Jan. 1, 1998 discloses a PDA with wireless data access. This device makes use of a proprietary set of network servers to ‘clip’ data from Web Sites and to prepare the information in an appropriate format for devices using the Palm Operating System, or the Palm OS. Currently, these networks do not make use of automatically determining the subscriber's current location in order to deliver appropriate services and information.

Computer protocols have been developed that allow for the transfer of Internet content to wireless devices. The telephones have evolved to provide for a larger display of information. As a subset of WWW protocols, Wireless Application Protocol (WAP) enables the conversion of Hyper Text Markup Language (HTML) or Extensible Markup Language (XML) formatted information into a thinner more streamlined set of data based on format such as Wireless Markup Language (WML) or Handheld device markup Language (HDML) format. WWW Server sites are preparing their information to be more suitable for transfer to WAP devices. These services are available to the public at the present on a limited basis. One provider of such service is Yahoo! (Yahoo! Mobile) which brings the services provided to PC users such as directory services, driving direction and others to mobile users. A handheld device having a mini-browser may connect to yahoo! Mobile and gets the services otherwise available only to PC users.

Access to Internet content from handheld device constitutes a new reach for providing access to information from everywhere. Public Directory information contained in phone books and other databases available across a network, as in “Big Yellow”—a legacy from telephone company databases that produced printed directories—now being made available on line can also be accessed from a handheld device.

Search engines built within most Web portals are generally used as tools to search information online. Directory services, and maps services are also available on most web portals such as, Yahoo!, Excite, AltaVista, etc. the maps services include driving directions and mapping a specific address into a digital map.

Search engines are capable of searching indexes or catalogs built of the content of the web. Catalogs of web content are built by sending a computer program capable of scanning and indexing each website available at a given point in time. The scanning or crawling programs work continuously to update the index as the web content grows and changes. These crawlers only access static web pages and are not accessing the databases that drive the dynamic web pages built with information based on a specific database query. These databases, which also include the public directories, are currently referred to as the ‘deep web’ or the information available through the web that is not contained in static pages.

While directories, maps, and search engine results are made available through the same portal, no specific index has been built that combines directory information, search engine catalogs and location information in a single index and thereby providing a superior search tool.

For the foregoing reasons, there is a need for a method and system that provide location-based information. In particular, there is a need for providing a location-indexed database that combines directory information as well as Internet content for an efficient and real-time access to location-specific information.

### SUMMARY OF THE INVENTION

The present invention relates to a method and system for providing location-based information to a mobile or fixed user. In one embodiment, the method for providing location-based information comprises the steps of (1) receiving a request for information from a subscriber via a subscriber device; (2) determining the geo-location of the subscriber's current location; (3) searching through a location-indexed database to identify web servers addresses of entities hosting information related to the requested information and which are within a preset radius of the subscriber's current location; (4) directing a search through said identified web servers to retrieve said related information; and (5) presenting the information to the subscriber organized with respect to the subscriber device. The subscriber device may be a handheld device such as mobile phone or wireless personal digital assistant (PDA) or a desktop or Laptop personal computer (PC).

In another embodiment, a method for providing location-based information to a subscriber is described; the method comprises the steps of (1) receiving a request for information from a subscriber; (2) determining the geo-location of the subscriber's current location; (3) retrieving from a location-indexed database information related to the requested information wherein said information is originally hosted by entities within a preset radius of the subscriber's current location; and (4) presenting the retrieved information to the subscriber.

According to another embodiment, a method for providing location-based information to a subscriber is disclosed. The method comprises the steps of (1) receiving a request for information from a subscriber wherein the request specifies a location-based search option; (2) determining the geo-location of the subscriber's current location; (3) retrieving from a location-indexed database information related to the requested information wherein said information is originally hosted by entities within a preset radius of the subscriber's current location; and (4) presenting the retrieved information to the subscriber.

These and other features and objects of the invention will be more fully understood from the following detailed description of the preferred embodiments that should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates a use case diagram of the location-based information delivery system;

FIG. 2A illustrates a generic platform for providing location-based information;

FIG. 2A illustrates a platform for providing location-based information to a mobile user; and

FIG. 3 illustrates an activity diagram for providing location-based information.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

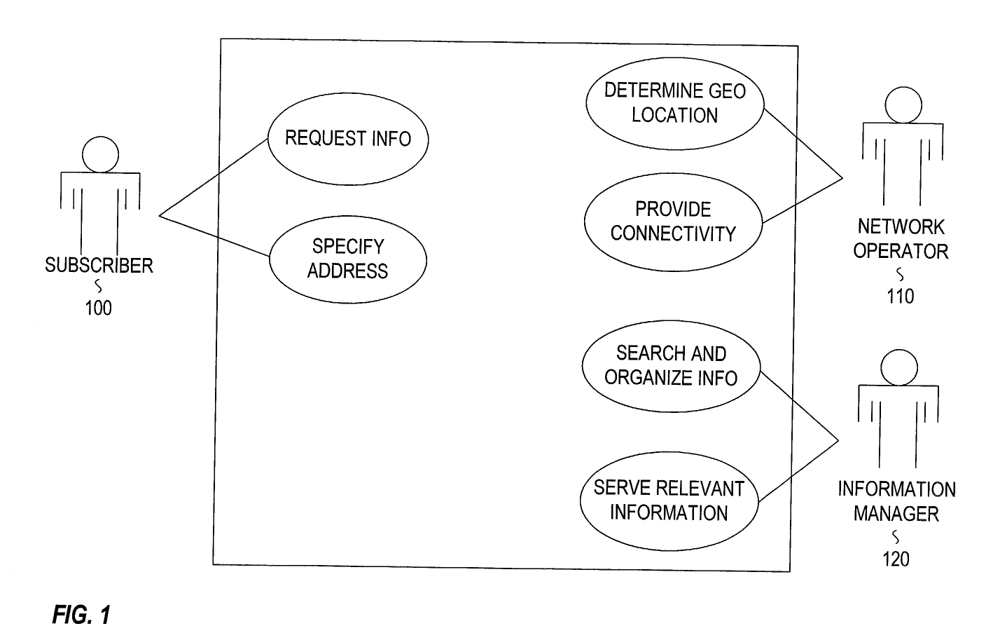

With reference to the drawings, in general, and FIGS. 1 through 3 in particular, the method and system of the present invention are disclosed.

FIG. 1 illustrates a use case diagram for providing location-based information to a mobile or fixed user. The actors involved in such a system include a subscriber 100, a network operator 110 and an information manager 120. The subscriber 100 requests information (130) related to their location from a communication network and receives the requested information organized and formatted according to the subscriber's current location and device.

The subscriber 100 may use a desktop personal computer (PC) which hereinafter will simply be referred to as a “desktop”, a laptop or mobile PC “laptop”, a wireless phone, a PDA, other fixed location devices, or other mobile devices. The subscriber 100 connects to the network via either a wired or a wireless connection. In order for the subscribers request (130) to be processed the subscribers location must be specified (140). There are numerous means for the subscriber specifying their address (140). For example, the subscriber may specify its current location by typing the location address on a graphical interface such as a web browser. The location may be determined based on an internet (IP) address for the device (i.e., desktop). The network operator 110 may use triangulation techniques or other known techniques to determine the geo-code or the geo-location of the subscriber's current location. The subscribers device may be provided with Global Positioning System (GPS) capabilities for sending the coordinates of the current location to the network operator 110.

The network operator 110 determines the geo-location (150) of the subscriber from the signal received from the subscriber device or by mapping the street address entered by the subscriber into a geo-location. The geo-code or geo location refers to the coordinates of the location in terms of longitude and latitude and may also include an altitude component. The network operator 110 also provides connectivity (160) to the network and interconnectivity between the subscriber 100 and the information manager 120. The information manager 120 receives location coordinates associated with the subscriber 100 from the network operator 110, and the request for information from the subscriber 100. The network operator searches for and organizes information related thereto (170). According to one embodiment, the information manager 120 searches through a database indexed by geo-location and identifies sources with the requested information that are in the vicinity of the subscriber's current position. The information manager 120 then serves the relevant information (180) to the subscriber 100.

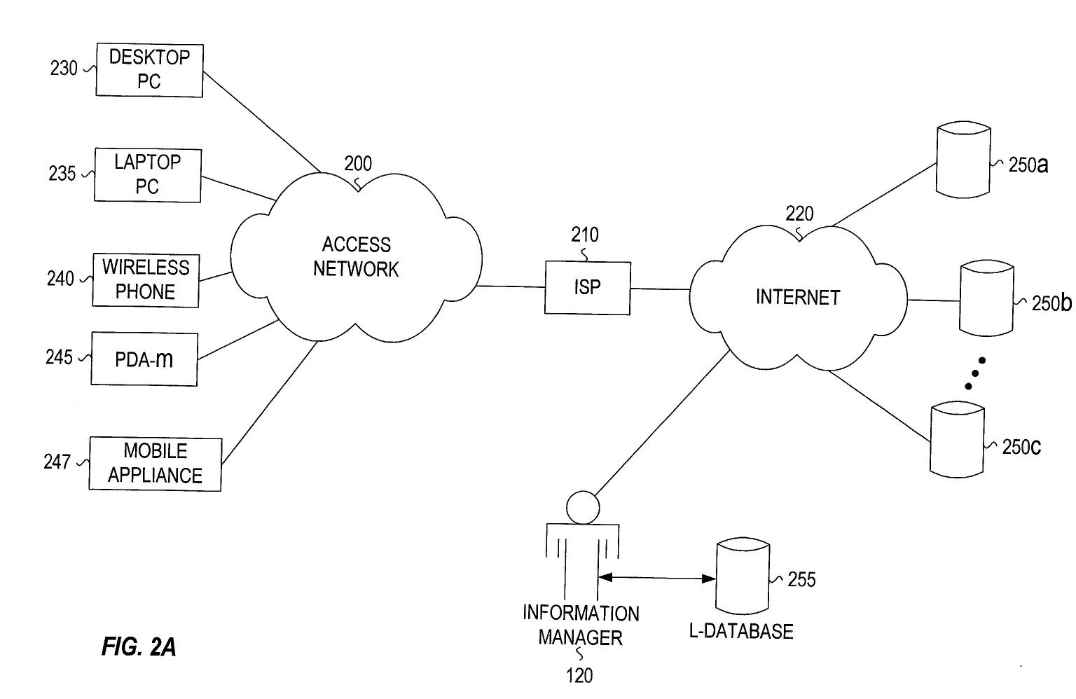

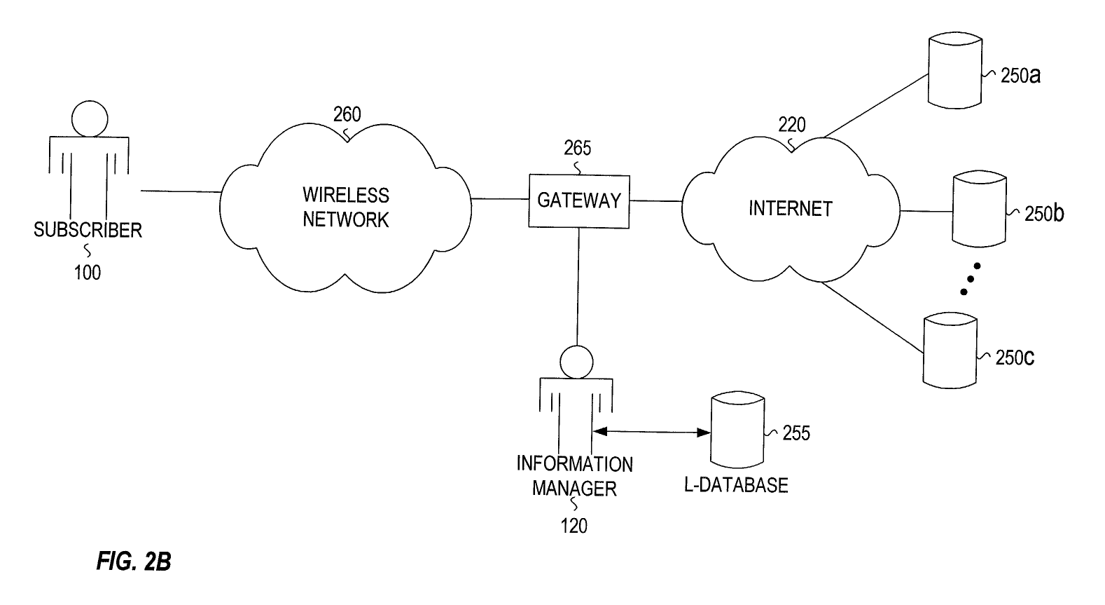

FIG. 2A illustrates an exemplary platform for providing access to the Internet. As illustrated, multiple different devices may connect (i.e., are capable of connecting) to the Internet 220, including, but not limited to, desktop 230, lap-top 235, wireless phone 240, wireless personal digital assistants (PDA-m) 245, TVs such as the WEBTV and AOLTV (not illustrated), and other mobile appliances 247. The devices are connected to the Internet 220 via an access network 200 and a service provider, such as an Internet service provider (ISP) 210 that provides the connectivity to the Internet 220. The access network may be a digital broadcast satellite (DBS) system, a cable television (CATV) system, a Switched Digital Video System (SDV), or other systems now known or later discovered. The system architectures can include Hybrid Fiber Coax (HFC), Fiber to the Curb (FTTC), Fiber to the Home (FTTH), any iteration of Digital Subscriber Loop (xDSL) including very high speed DSL (VDSL), terrestrial wireless networks such as multichannel multipoint distribution systems (MMDS) or local MDS (LMDS), or other architectures now know or later discovered system.

A plurality of servers 250a-c are connected to the Internet 220 and store web content which can be accessed by the various devices connected to the access network 200. The information manager 120, which provides information relative to current location, is also connected to the Internet 220. The information manager 120 is illustrated being separate from the ISP 210, however, it could easily be hosted by the ISP 210. The information manager 120 may maintain its own web server (not illustrated). The information manager 120 communicates with a location database 255, which combines directory information and Web content or Web addresses and which is indexed by geo-location. In one embodiment, the L-database 255 stores the entities providing information that may be requested by a subscriber along with their web servers addresses and the information is indexed by geo-location or street address. The use of the L-database 255 allows the information manager 120 to perform a location-based search by querying the L-database 255 using location coordinates or street addresses. In another embodiment, the information manager 120 also stores the web content of the entities identified in the L-database 255 to directly service the subscriber without the need to access the web server hosting the originally requested information. The web content stored by the information manager 120 may be updated frequently to reflect the latest changes on the original web server.

According to one embodiment, a web browser may serve as a portal for accessing location-based information. The subscriber 100 connects to the web server and requests the information using a graphical user interface (GUI). The GUI may have a built-in function for specifying different search options (or preferences). For example, an “L-Go” button may be part of the browser for specifying a location-based search option. When the “L-Go” button is activated, the information manager 120 performs its search to retrieve location-based information with respect to the current subscriber location. This search option may be desirable to differentiate between a generic search as is known in the prior art search engines and a location-based search as disclosed herein. In the case where the subscriber uses a handheld device such as a mobile phone or a PDA-m, the handheld device may have a wireless application protocol (WAP) enabled browser for accessing Internet content and for requesting information.

FIG. 2B illustrates an exemplary platform for providing access to the Internet. As illustrated, a subscriber 100 is connected to a wireless network 260. While not illustrated, the subscriber 100 may use a wireless phone, wireless PDA, laptop having a wireless modem, or other wireless devises to connect to the wireless network 260. A wireless network operator provides connectivity to the Internet 220 by providing a router or gateway 265 at the edge of the wireless network 260. The router/gateway 265 routes traffic destined to the Internet 220 and translates the Hypertext Markup Language (HTML) format of the content received from the web servers 250a-c connected to the Internet 220 into a format, such as the Wireless Markup Language (WML), readable by the wireless devices. The router/gateway 265 may be a WAP enabled gateway, which allows content to be optimized for transmission over the wireless network and for display on a WAP-enabled device (e.g., PDA-m or wireless phone).

As illustrated, the router/gateway 265 is coupled to the information manager 120 to provide the location-based information. The information manager 120 could also be part of (hosted by) the router/gateway. Alternatively, the information manager 120 may be a distinct entity completely separate from the router/gateway 265 that is connected to the Internet 220 and which the subscriber accesses through the Internet 220.

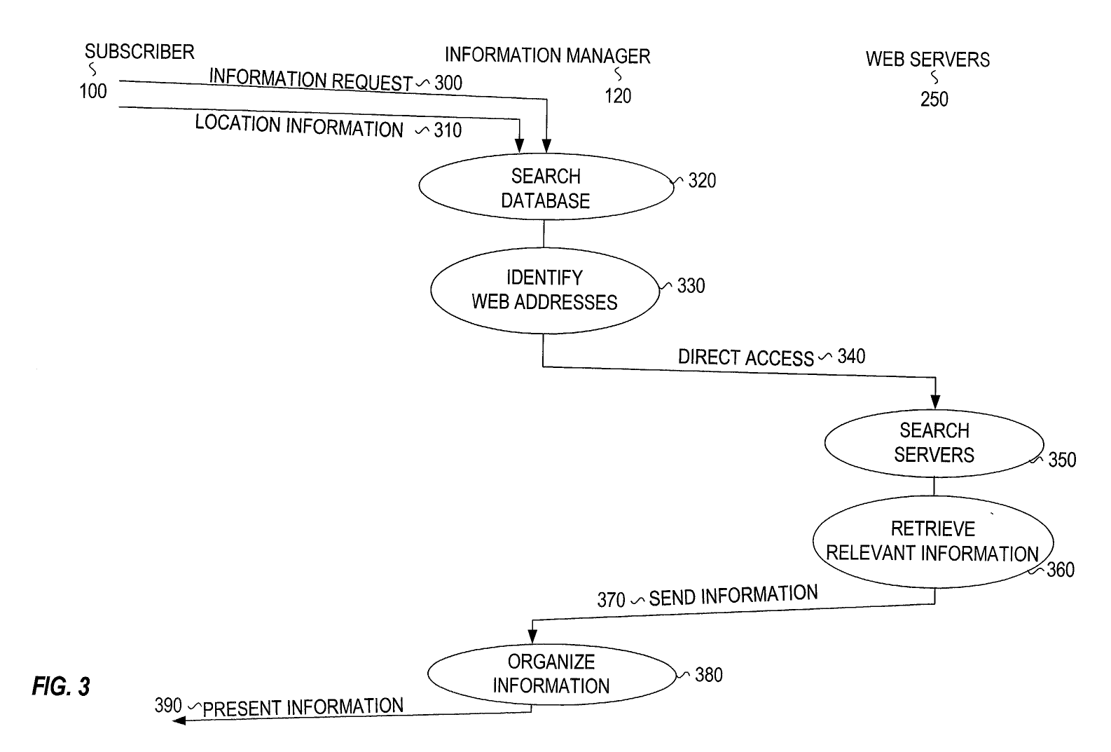

FIG. 3 illustrates an exemplary activity diagram for the location-based information delivery method of the present invention. The subscriber 100 requests information 300 through a web browser on a device (desktop, wireless phone, PDA) that connects to the Internet 220 via an access network 200 or wireless network 260. The connection may be based on a dial-up mode Point-to-Point Protocol (PPP) or other connection modes. The subscriber's current location 310 and the information request 300 are sent to the information manager 120. The location information 310 may be entered by the user, provided by a GPS chipset embedded within the wireless device, determined by the network operator using localization techniques such as triangulation, or other known techniques.

The information manager 120 performs a search 320 of a database indexed by geo-location to identify the web servers 330 of the entities which host information related to the requested information and which are within a preset radius of the subscriber's current location. In one embodiment, the information manager 120 directs access 340 to each of the identified web servers. In this embodiment, only the web servers identified as hosting information relevant to the subscriber's request are accessed and a search 350 is performed on the servers to retrieve the relevant information 360.

The relevant information is then forwarded 370 to the information manager 120 which organizes the information 380 received from the different servers and presents the information 390 to the subscriber 100 with a format supported by the subscriber device.

The present invention may be adopted by a network operator or by a service provider to deliver enhanced and new revenue-generating services for their mobile subscribers. The method of the present invention may be used to find any type of information including, but not limited to, entertainment news (e.g., movies), restaurant menus or dishes and other information.

The method disclosed herein also constitutes a new search paradigm, wherein the search is limited within a certain location area and wherein real time access to web servers hosting the requested information is provided to retrieve and present updated information to the user as opposed to only presenting a link to the web server. This feature is particularly useful for a mobile user with a handheld device since it provides the information needed with no direct interaction with the host servers, thus reducing the time to access the information. An illustrative scenario where the present invention may be applied is the example of a mobile user roaming in a new location with a handheld device and wishing to have “Chicken Parmesan” for dinner. The mobile user can then elect to search for “Chicken Parmesan”. The information manager 120 then receives location information for the subscriber and searches through its location-indexed database to identify establishments having “Chicken Parmesan” specified on their website and being within a pre-set radius of the subscriber location. According to one embodiment, the preset location will be only in the direction of travel of the subscriber so as to avoid providing establishments that are behind the subscriber. According to one embodiment, the information manager 120 further accesses the identified establishments (restaurants') web servers and retrieves the dinner menus which include “Chicken Parmesan”. The retrieved set of menus is then presented to the mobile user.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A method for providing location-based information, the method comprising:
receiving a request for information from a subscriber via a subscriber device;
determining geo-location associated with current location of the subscriber;
searching through a location-indexed database to identify web server addresses of entities hosting information related to the requested information which are within a preset radius of the subscriber's current location;
directing a search through said identified web servers to retrieve information related to the requested information; and
presenting the related information to the subscriber organized with respect to distance form the subscriber device.

2. The method of claim 1, wherein the subscriber device is a desktop PC or a Laptop PC.

3. The method of claim 1, wherein the subscriber device is a handheld device.

4. The method of claim 3, wherein the handheld device is a personal digital assistant.

5. The method of claim 3, wherein the handheld device is a cellular phone.

6. The method of claim 1, wherein the geo-location is determined by mapping a street address specified by the subscriber into geo-location coordinates.

7. The method of claim 1, wherein the geo-location is determined based on radio frequency (RF) signals received from the subscriber's device.

8. The method of claim 1, wherein the geo-location is determined based on GPS signals received from the subscriber's device.

9. A method for providing location-based information to a subscriber, the method comprising:
receiving a request for information from a subscriber;
determining geo-location associated with current location of the subscriber;
retrieving from a location-indexed database information related to the requested information, wherein the related information was originally hosted by entities within a preset radius of the subscriber's current location; and
presenting the retrieved information to the subscriber.

10. The method of claim 9, wherein said receiving includes receiving a request for a location based search if a location based search option is enabled.

11. The method of claim 10, wherein the location based search option is a location button on a browser.

12. The method of claim 9, wherein the geo-location is determined by mapping a street address specified by the subscriber into geo-location coordinates.

13. The method of claim 9, wherein the geo-location is determined based on radio frequency (RF) signals received from the subscriber's device.

14. The method of claim 9, wherein the geo-location is determined based on GPS signals received from the subscriber's device.

15. A system for providing location-based information to a subscriber, the system comprising:
a location-indexed database for storing web server addresses of entities providing information to be requested by the subscriber using a subscriber device; and
an information manager for searching through the location-indexed database to identify web server addresses of entities hosting information related to the requested information and which are within a preset radius of current location of the subscriber.

16. The system of claim 15, further comprising an access network for providing the subscriber with access to Internet.

17. The system of claim 16, further comprising a gateway for interfacing said access network and said information manager, wherein said gateway translates data received by said information manager into a format suitable to the subscriber device.

18. The system of claim 16, further comprising a public network, wherein said information manager is connected to said public network.

19. The system of claim 18, further comprising a gateway for interfacing said access network and said public network, wherein said gateway translates a signal received from said public network into a format suitable to the subscriber device.

20. The system of claim 15, further comprising means for determining current location of the subscriber.
